(19) United States
(12) Patent Application Publication
(10) Pub. No.: US 2018/0252618 A1
(43) Pub. Date: Sep. 6, 2018

(54) TIRES FOR TESTING FORCE VARIATION SENSITIVITY IN A VEHICLE

(71) Applicant: GM GLOBAL TECHNOLOGY OPERATIONS LLC, Detroit, MI (US)

(72) Inventors: Kenneth L. Oblizajek, Troy, MI (US); John D. Sopoci, Commerce Township, MI (US)

(21) Appl. No.: 15/446,577

(22) Filed: Mar. 1, 2017

(51) Int. Cl. G01M 17/007; G01M 7/02; B24B 5/36

(52) U.S. Cl. CPC G01M 17/007; B24B 5/366; G01M 7/022

(57) ABSTRACT

A method for testing a vehicle includes designing a tire that has a runout as a function of an angular position of the tire that induces a desired vibration in a vehicle when the tire operates on the vehicle. The method also includes performing a test on the vehicle while operating the vehicle with the tire having the design that induces a desired vibration in a vehicle.

### INTRODUCTION

The subject application relates to testing the influence of dynamic force and moment variations acting on and within a vehicle.

Testing vehicles for vibrations is accomplished using a variety of methods that allow vehicle vibration sensitivities to be quantified. The tests of interest often include inducing vehicle-internal periodic forces and moments in multiple directions and at different orders of the rotation rate of various rotating components. One type of test intentionally induces vibrations in the vehicle at multiple orders of the tire rotation rate by providing predefined forces and moments to the vehicle suspension.

Typical suspension vibrations may be caused by, for example, imbalances in the system, runout, and internal variations in the structural composition of the tire. Tires, for example, are components that tend to induce disproportionate internal vibrations in vehicles. Accordingly, it is desirable to provide a way to efficiently and effectively test these vehicle vibration sensitivities.

### SUMMARY

According to an exemplary embodiment, a method for testing a vehicle includes designing a tire that has a runout as a function of an angular position of the tire that induces a desired vibration in a vehicle when the tire operates on the vehicle. The method also includes performing a test on the vehicle while operating the vehicle with a tire having the design that induces a desired vibration in a vehicle.

In addition to one or more of the features described herein, or as an alternative, further embodiments include fabricating the tire.

In addition to one or more of the features described herein, or as an alternative, further embodiments include wherein the fabricating the tire includes removing material from the tire to result in a tire having a runout as a function of an angular position of the tire that induces a desired vibration in a vehicle when the tire operates on a vehicle.

In addition to one or more of the features described herein, or as an alternative, further embodiments include wherein the fabricating the tire includes using a tire grinding system.

In addition to one or more of the features described herein, or as an alternative, further embodiments include wherein runout includes a distance from a center of rotation of the tire and a portion of the tire that is operative to contact a road surface.

In addition to one or more of the features described herein, or as an alternative, further embodiments include wherein the designing the tire includes identifying parameters of the vibrations desired to be induced by the tire on the vehicle, constructing a spectrum as a function of the identified parameters, and outputting a runout as a function of the angular position of the tire.

In addition to one or more of the features described herein, or as an alternative, further embodiments include wherein the identified parameters include vibratory orders of interest.

In addition to one or more of the features described herein, or as an alternative, further embodiments include wherein the identified parameters include amplitudes of vibratory orders of interest.

In addition to one or more of the features described herein, or as an alternative, further embodiments include wherein the identified parameters include phase components by order, and the spectrum is a complex spectrum.

According to another exemplary embodiment, a method for controlling a tire grinding system includes inputting a tire design to a controller of the tire grinding system, the tire design having a at least one of a force, a moment and a runout variation as a function of an angular position of the tire that induces a desired vibration in a vehicle when the tire operates on a vehicle, and controlling a position of a grinding stone relative to an axis of rotation of a tire. The method further includes removing portions of the tire with the grinding stone to result in forming the tire with the tire design.

In addition to one or more of the features described herein, or as an alternative, further embodiments include wherein the position of the grinding stone is controlled as a function of at least one of a sensed force, a sensed moment and a sensed runout.

In addition to one or more of the features described herein, or as an alternative, further embodiments include wherein the position of the grinding stone is also controlled as a function of at least one of the position of the grind platform and the grind motor effort.

In addition to one or more of the features described herein, or as an alternative, further embodiments include wherein runout is a distance between an axis of rotation of the tire and a surface of the tire that contacts a road surface during operation.

In addition to one or more of the features described herein, or as an alternative, further embodiments include wherein the tire with the tire design is operative to induce high order vibrations in a test vehicle.

In addition to one or more of the features described herein, or as an alternative, further embodiments include wherein the tire design is a function of identified parameters of vibrations desired to be induced in a test vehicle.

In addition to one or more of the features described herein, or as an alternative, further embodiments include wherein the identified parameters include vibratory orders of interest.

In addition to one or more of the features described herein, or as an alternative, further embodiments include wherein the identified parameters include amplitudes of vibratory orders of interest.

In addition to one or more of the features described herein, or as an alternative, further embodiments include wherein the identified parameters include phase components by order.

According to yet another exemplary embodiment, a tire includes a tread area, an axis of rotation, and a runout defined as a distance between the tread area and the axis of rotation, where the runout varies as a function of an angular position of the tire such that the tire is operative to induce a desired vibration in a vehicle while operating.

In addition to one or more of the features described herein, or as an alternative, further embodiments include wherein the tire is substantially purposely runout deformed such that the tire induces a desired vibration during vehicle testing.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a block diagram of an exemplary vibration testing method;

FIG. 2A illustrates a side view of an exemplary embodiment of a test tire (tire) prior to modification;

FIG. 2B illustrates a side view of an exemplary embodiment of the tire following modification;

FIG. 3 illustrates a front view of the tire following modification;

FIG. 4 illustrates a block diagram of an exemplary method for designing a tire that will induce desired vibrations in a test vehicle;

FIG. 5 illustrates a graph that includes a plot that indicates the design of the modified tire by plotting the desired runout versus angular position of a tire;

FIG. 6 illustrates a tire grinding system;

FIG. 7 illustrates a block diagram of an exemplary processing system that may be used to design the tire; and

FIG. 8 illustrates a block diagram of an exemplary method for controlling the tire grinding system.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Testing a vehicle for vibration sensitivity may be effectively performed by inducing forces on the vehicle at “suspension corners” of the vehicle e.g., by means of the tires of the vehicle. Vehicle vibration sensitivity affects the performance of the vehicle and the comfort of the driver and passengers.

During a vibration test, different orders (e.g., 1^{st}-10^{th} orders) of vibrations are induced on the vehicle to identify vibration sensitivities depending on the rotation rate of the corner assembly comprising a tire and a wheel. Once vibration sensitivities are identified, the vehicle may be modified to correct for the undesirable vibration sensitivities.

Previous methods for inducing vibrations in vehicles included selecting tires that induce a desired vibration on a vehicle from a host of manufactured tires. Such an approach has drawbacks since it is time consuming and costly. The prior methods used a very large variety of tires to create a distribution of desired higher order vibrations, which presented a practical and logistical burden.

The methods and systems described herein provide for identifying the frequencies, amplitudes, and relative phases of vibrations that a tester would like to induce on a vehicle during a vibration test. Once the desired vibrations are determined, a tire tread is formed having a profile that will induce the desired vibrations on the vehicle when mounted to the vehicle during vehicle vibration testing. Thus, by modifying a tire to induce desired vibrations on a test vehicle, first through higher orders of vibrations may be easily tested.

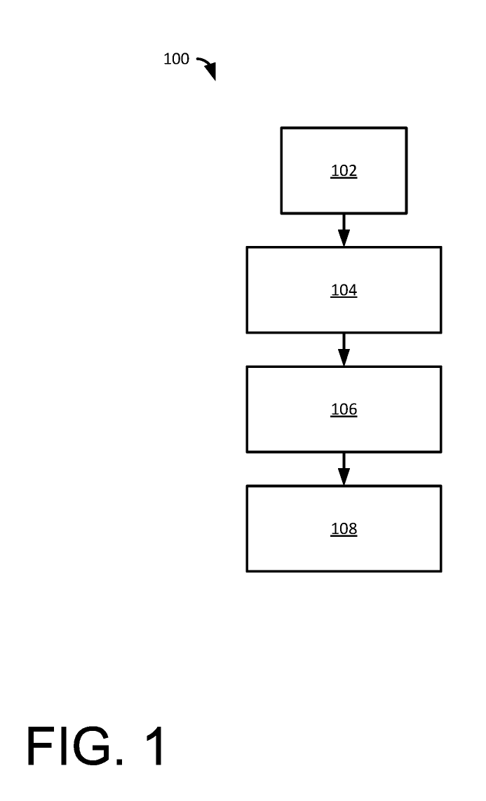

FIG. 1 illustrates a block diagram of an exemplary vibration testing method 100 that will be described in further detail herein. In block 102, a test tire is designed that has a runout as a function of the angular position of the tire to induce the desired vibrations in the test vehicle. In block 104 a test tire is fabricated that has the designed runout as a function of the angular position of the tire to induce the desired vibrations in the test vehicle. In block 106, the test tire is mounted to a test vehicle. The vehicle vibration test is performed in block 108 such that vibrations including high order vibrations are induced by the tire on the test vehicle. Following the vibration test, components of the vehicle may be modified or adjusted to reduce the vibrations in the test vehicle.

Additional supplemental laboratory measurements of the tires and wheels on conventional tire and wheel force variation equipment may be employed to quantify or validate the vehicle sensitivity results. The force variation measurements and the results of the vehicle vibration testing, 108, are collectively analyzed in order to estimate sensitivities.

The particular methods and approaches used by the skilled analyst vary and are generally selected based on efficacies, expedience and available processing tools. The illustrated exemplary embodiments address the preparation of the test tires by fabricating (or modifying) readily available tires with preferred force variation over a band of orders. By fabricating such test tires that will induce the preferred forced variation over a band of orders, the testing may avoid using large quantities of “off the shelf” test tires. Using such test tires resulted in a cumbersome, less effective, less efficient, and more expensive testing process.

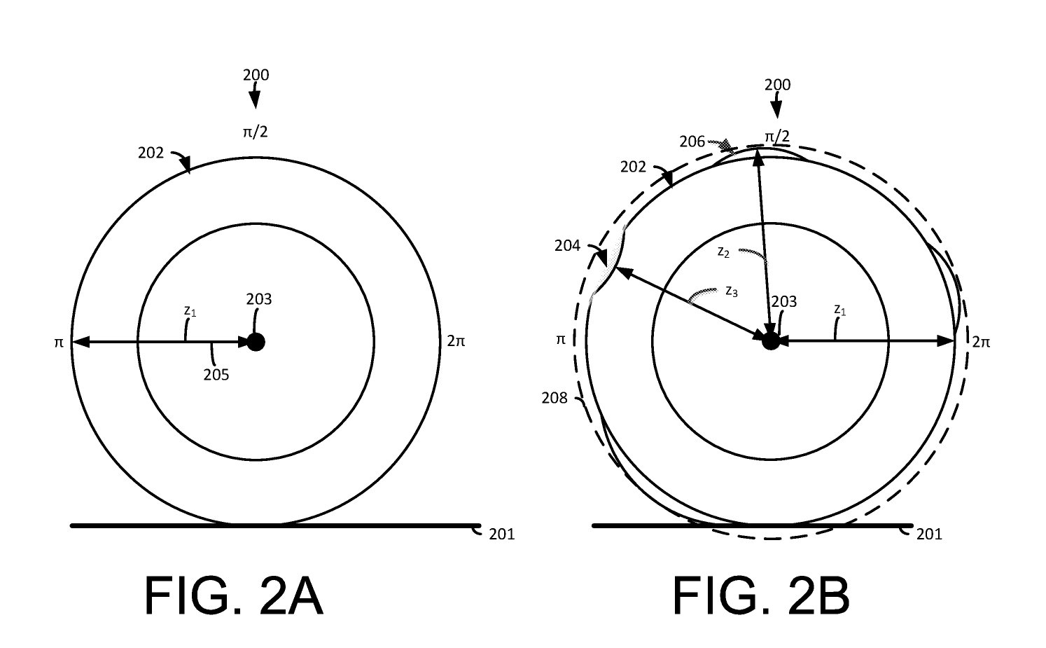

FIG. 2A illustrates a side view of an exemplary embodiment of a test tire (tire) 200 prior to modification, and FIG. 2B illustrates a side view of an exemplary embodiment of the tire 200 following modification using a method that will be described further herein.

In this regard, the tire 200 includes a contact surface 202. The contact surface 202 (includes the tread area) is the portion of the tire 200 that contacts the roadway or operating surface 201 as the tire 200 rotates when mounted on a vehicle. The tire 200 includes an axis of rotation 203. The distance between the contact surface 202 and the axis of rotation 203 is called the runout and is represented by the line 205.

FIG. 2B illustrates an exemplary embodiment of the tire 200 after the tire has been modified to have a runout (z₁, z₂, z₃) that changes radially along the contact surface 202 of the tire 200. The tire 200 includes regions 206 with longer runouts, termed rises, and regions 204 with relatively shorter runouts, termed depressions. In operation, when mounted on a vehicle during testing, the varying runout along the contact surface 202 results in the inducement of desired vibrations on the vehicle during testing. The tire 200 is substantially “purposely runout deformed,” which in some embodiments, may result in the desired vibrations. Achieving the relative rises 206 and depressions 204 by removing rubber at the tread contact surface 202 generally results in relative amounts of rubber removal from the tires initial outer contact zone 208.

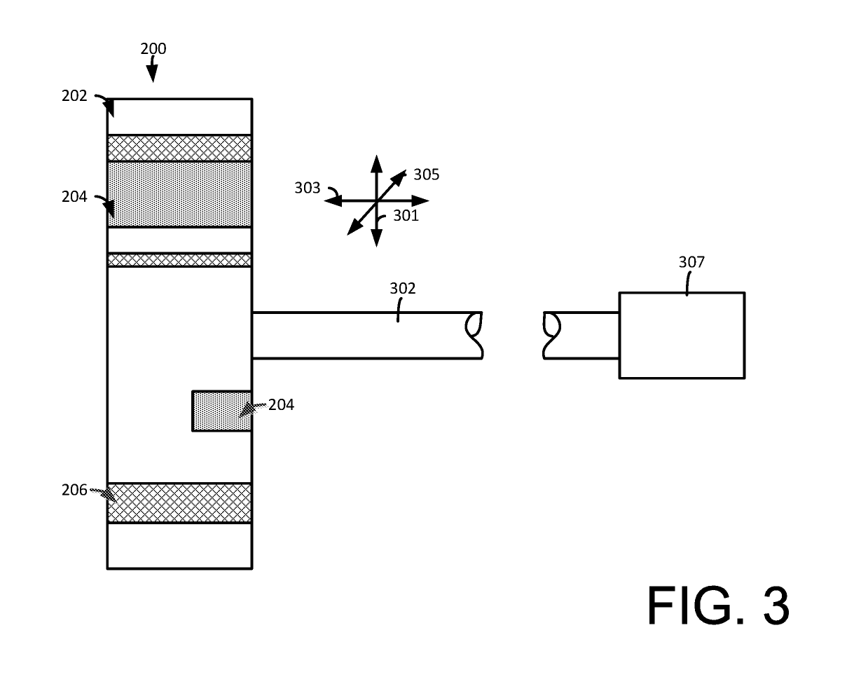

FIG. 3 illustrates a front view of the tire 200 following modification. The tire 200 rotates on an axle 302 that is connected to a test vehicle 307. The tire 200 includes the contact surface 202 that has regions 206 and 204 having longer and shorter runouts respectively. The regions 206 and 204 may be arranged across (running from sidewall to sidewall of the tire 200) the contact surface 202 or may be formed in the center or may be formed partially across the contact surface 202. The regions 206 and 204 may include tread, shoulder, blocks, ribs, and slopes of the tire 200 and collectively any region that contacts the road surface, and/or may induce a vibration on the vehicle along the axis 301, 303 and 305. Rotational vibrations may also be induced with angular vibrations acting around the three axes 301, 303 and 305.

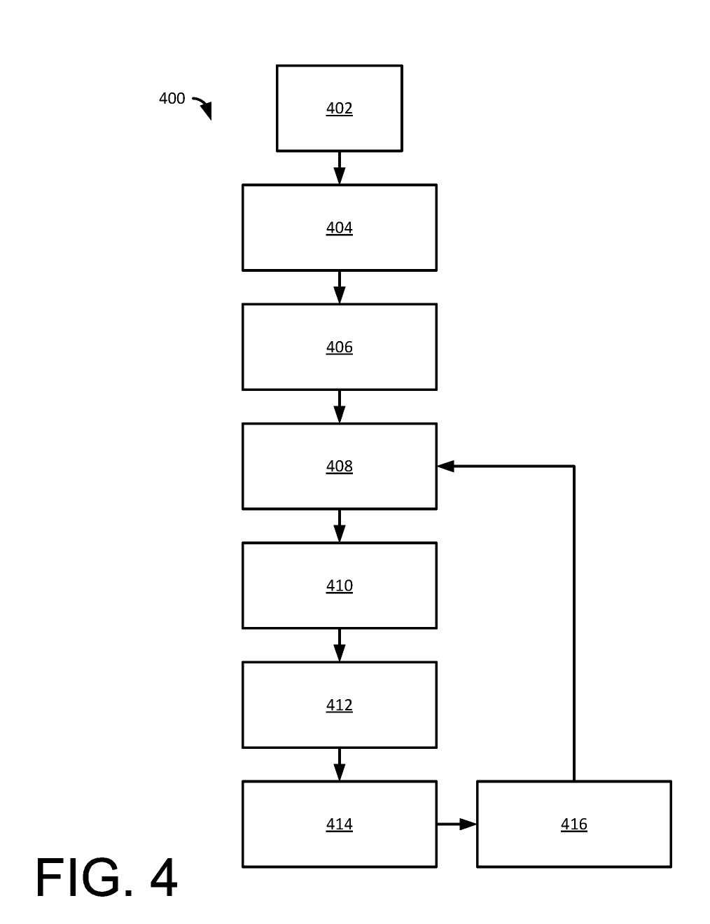

FIG. 4 illustrates a block diagram 400 of an exemplary method for designing a tire that will induce desired vibrations in a test vehicle. In this regard, the resultant tire will have a varying runout through the angular position of the tire. In block 402, the user identifies orders of interest. Identified orders of interest are the harmonic orders of vibration that the user would like to induce on the test vehicle. In block 404, the user designates or selects the amplitudes of vibration for each of the identified orders of interest. In block 406, the user identifies the initial order phases that will be induced by the tire.

Once the design specifications are identified and designated a spectrum is constructed as a function of the designated amplitudes in block 408. If non-zero phase magnitudes are introduced, the spectrum becomes a complex spectrum, having amplitude and phase, or alternatively, real and imaginary components.

In block 410 the spectrum may be transformed to be a function in the domain of tire rotation angle using, for example, an inverse Fourier transform, most frequently implemented in widely recognized formulations and identified as “inverse Fast Fourier Transforms” (iFFT). In block 412, the runout versus angle of tire rotation is output as control data. The runout versus angle of tire rotation represents the design of the modified tire that will induce the desired vibrations on the test vehicle 307.

In some exemplary embodiments, the runout versus angle of tire rotation may be used with applied performance criteria in block 414 to determine whether the parameters have been optimized. If not, the parameters may be optimized in block 416, and an updated complex spectrum may be constructed in block 408.

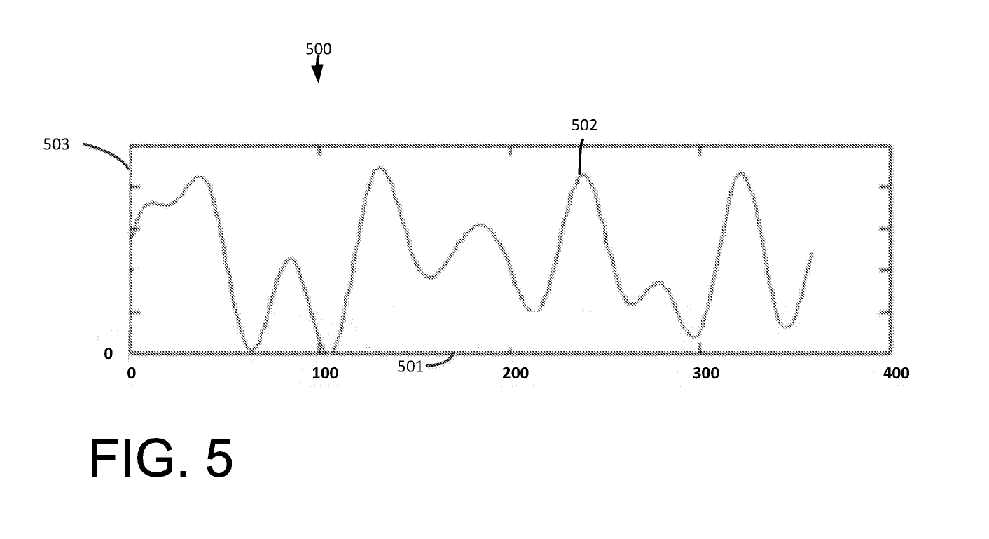

FIG. 5 illustrates a graph 500 that includes a plot 502 that indicates the design of the modified tire by plotting the desired runout versus angular position of a tire. In this regard, the horizontal axis 501 indicates the angular position of the tire in degrees, while the runout is shown on the vertical axis 503. Further elaborating, and referring to the graph 500, the tire runout is shown relative to the absolute minimum of the runout at the approximately 105 degrees position while the tire runout is greater at the approximately 320 degree position.

Once the design of the modified tire is determined, the tire may be modified using, for example, a tire grinding system.

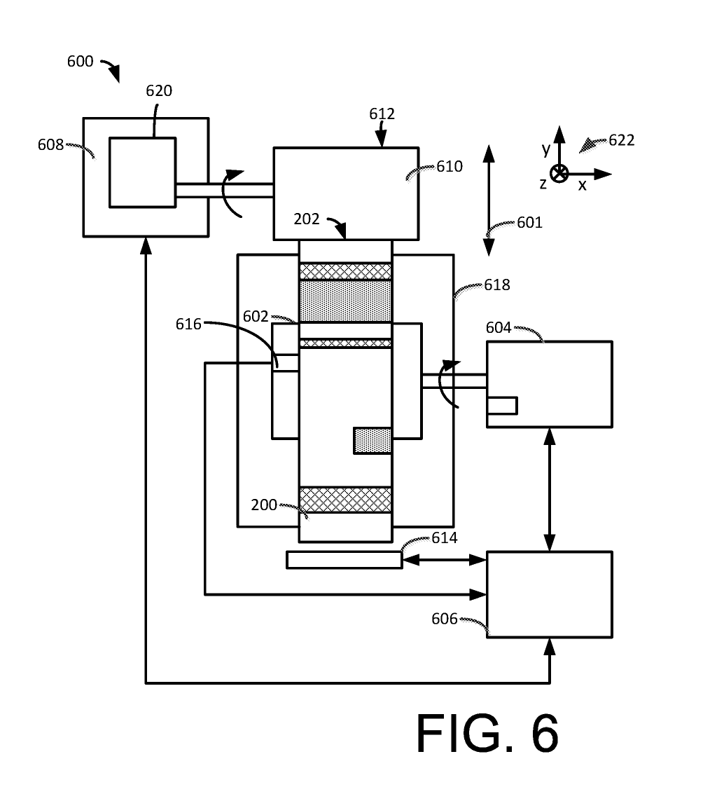

FIG. 6 illustrates a tire grinding system 600. The system 600 is operative to fabricate a modified tire that has a design that will induce the desired vibrations in the test vehicle. The system 600 includes a rotating portion 602 (for example a hub) that retains the tire 200 and is connected to a motor 604 that is operative to rotate the tire 200 about the axis of rotation of the tire 200. A grind platform 608 is connected to a grind stone 610 having a grinding surface 612 that contacts the contact surface 202 of the tire 200. The grind platform 608 may move linearly along the line 601 to change the distance between the tire and the grinding surface 612 of the grind stone 610.

The grind platform 608 supports a grind motor 620, which rotates the grindstone 610. The tire is forced to contact a freely rotating loading drum 618 that is initially positioned to produce a mean load on the tire approximating usage on a vehicle. After achieving the prescribed mean load, the rotation axis of the loading drum 618 is subsequently locked in position by immovably locking grind platform 608, permitting force and moment variation measurements sensed by strategically located transducers reacting the load of the loading drum 618 as it continues to freely move about its rotation axis.

Although the grind stone 610 is shown in FIG. 6 as extending over the entire face of the tire, alternate exemplary embodiments include other grind stone 610 shapes. Grind stones 610 may be shorter in width contacting certain lateral portions of the tread contact surface 202. A configuration with such restricted contact may use two grindstones, one at each of the lateral extremities of the tread contact surface 202; another configuration may use one centrally located short grind stone at the center of the contact surface 202. Still another configuration may include both of the above grind stone configurations, ultimately using three grind stones. The creation of tire moments about the x and z axes 622 of FIG. 6, can also be achieved by inducing asymmetric runout variation at the lateral tread contact 202 extremities. For example, a local depression 204 at the leftmost lateral tread contact zone 202 with a corresponding rise 206 at the rightmost lateral contact zone 202 produces a moment. Desired variations in moments can be achieved by the asymmetric grinding of depressions 204 and opposite rises 206. Furthermore, a combination of desired force variation and moment variation will result from the superposition of the respective symmetric and asymmetric tread zone regions.

The system 600 includes a controller 606 that is communicatively connected to the grind platform 608, the motor 604 and sensors. The controller 606 is operative to control the system 600 such that the grind stone 610 removes or grinds tire material from the contact surface 202 at particular tire angular positions to result in the desired modified tire 200.

In this regard, the controller 606 is communicatively connected to sensors 614 that may include, for example, optical sensors that calculate the runout of the tire 200 at a particular angular position. Sensors 616 include encoders or tachometers to provide for calculating the angular position of the tire 200. The motor 604 may also include, for example, a force transducer that determines the amount of force exerted on the tire 200 due to the rotation of the tire 200 by the motor 604 and the friction induced on the tire 200 by the grind stone 610.

The system 600 may be controlled using feedback from force transducers that sense and output the rotational force on the tire to the controller 606. Alternatively, the system 600 may be controlled using the position of the tire 200 and the measured runout of the tire 200. Thus, any method including for example, using measured force or measured runout may be used to control the system 600 to fabricate a desired test tire 200.

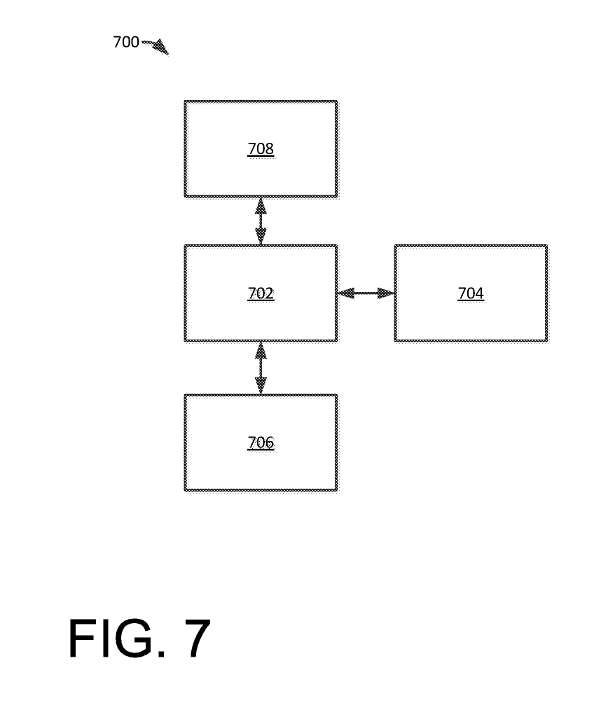

FIG. 7 illustrates a block diagram of an exemplary processing system 700 that may be used to design the tire 200 (of FIG. 2B), and in some embodiments, may be used to control the tire grinding system 600 (of FIG. 6). The system 600 includes a processor 702 that is communicatively connected to a memory 704, a display 706, and an input device 708. In other alternate embodiments, the processing system 700 may be used to design the test tire 200 while another processing system similar to the processing system 700 may also be used to control the tire grinding system 600.

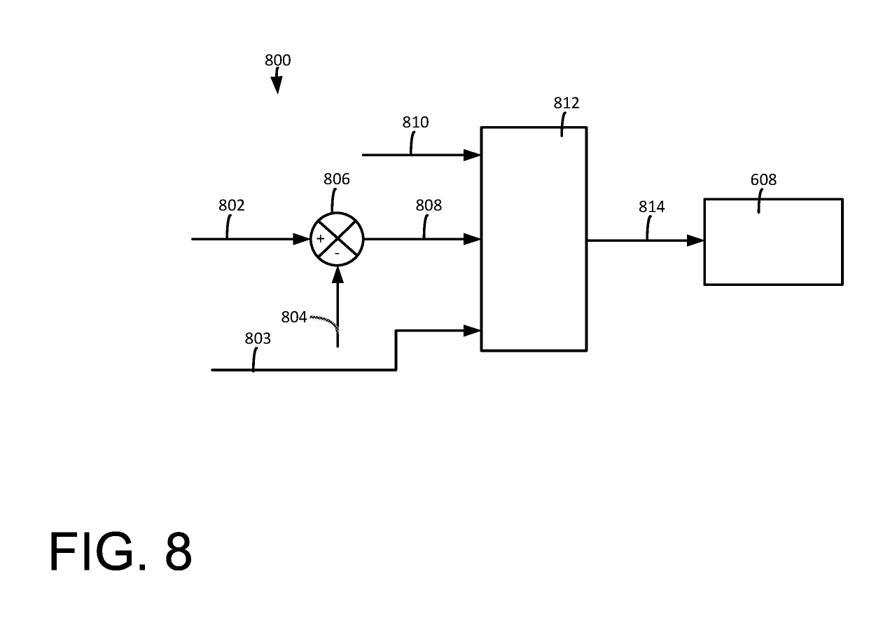

FIG. 8 illustrates a block diagram 800 of an exemplary method for controlling the tire grinding system 600 (of FIG. 6). In this regard, a signal 802 includes at least one of the desired tire runout and/or the desired force variation as a function of the angular position of the tire. The signal 802 is compared with the signal 804, which indicates the sensed feedback quantity corresponding to the desired control signal of the tire at a comparator 806 to output a control signal 808. The control signal 808, and a tire encoder signal 810 (i.e., tire angular position signal) are synchronized using logic in block 812 to result in a grind platform position signal 814 that is operative to control the position of the grind platform 608. In some embodiments a signal 803 that is indicative of the grind motor effort may also be received and synchronized in block 812.

Since the position of the grind platform 608 relative to the axis of rotation of the tire determines the tire material removed by the grind wheel, the position of the grind platform 608 is controlled to fabricate the desired test tire 200. The system 600 and the resultant signals in the block diagram 800 may be functions of sensed tire force, tire runout and sensed grind motor effort 816; the grind motor effort 816 may be assessed by the current draw on conventional multiphase electric motors. Since the force induced on the tire 200 by the rotatable loading drum 618, the runout of the tire 200, the position of the grind platform 608 and the power consumption of the grind motor 620 may be sensed by the system 600, the system 600 may be controlled, for example, by signals that are functions of force or radial distance (runout), augmented by the power consumption indicating grind motor effort 816 of the grind motor 620, ultimately and continuously positioning the grind platform 608 either closer to or farther away from the surface of the tire 202 including depressions at regions 204 or rises at regions 206.

The methods and systems described herein provide for designing and fabricating a test tire that induces a desired frequency, amplitude, and phase of vibration on a test vehicle when the test tire is used on the test vehicle. The test tire facilitates economic and effective vehicle vibration sensitivity testing at high order frequencies.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the application not be limited to the particular embodiments disclosed, but will include all embodiments falling within the scope of the application.

What is claimed is:

1. A method for testing a vehicle, the method comprising:
designing a tire that has a runout as a function of an angular position of the tire that induces a desired vibration in a vehicle when the tire operates on the vehicle; and
performing a test on the vehicle while operating the vehicle with the tire having the design that induces a desired vibration in a vehicle.

2. The method of claim 1, further comprising fabricating the tire.

3. The method of claim 2, wherein the fabricating the tire includes removing material from the tire to result in a tire having a runout as a function of an angular position of the tire that induces a desired vibration in a vehicle when the tire operates on a vehicle.

4. The method of claim 2, wherein the fabricating the tire includes using a tire grinding system.

5. The method of claim 1, wherein runout includes a distance from a center of rotation of the tire and a portion of the tire that is operative to contact a road surface.

6. The method of claim 1, wherein the designing the tire includes:
identifying parameters of the vibrations desired to be induced by the tire on the vehicle;
constructing a spectrum as a function of the identified parameters; and
outputting a runout as a function of the angular position of the tire.

7. The method of claim 6, wherein the identified parameters include vibratory orders of interest.

8. The method of claim 6, wherein the identified parameters include amplitudes of vibratory orders of interest.

9. The method of claim 6, wherein the identified parameters include phase components by order, and the spectrum is a complex spectrum.

10. A method for controlling a tire grinding system, the method comprising:
inputting a tire design to a controller of the tire grinding system, the tire design having a at least one of a force, a moment and a runout variation as a function of an angular position of the tire that induces a desired vibration in a vehicle when the tire operates on a vehicle;
controlling a position of a grinding stone relative to an axis of rotation of a tire; and
removing portions of the tire with the grinding stone to result in forming the tire with the tire design.

11. The method of claim 10, wherein the position of the grinding stone is controlled as a function of at least one of a sensed force, a sensed moment and a sensed runout.

12. The method of claim 11, wherein the position of the grinding stone is also controlled as a function of at least one of the position of the grind platform and the grind motor effort.

13. The method of claim 10, wherein runout is a distance between an axis of rotation of the tire and a surface of the tire that contacts a road surface during operation.

14. The method of claim 10, wherein the tire with the tire design is operative to induce high order vibrations in a test vehicle.

15. The method of claim 10, wherein the tire design is a function of identified parameters of vibrations desired to be induced in a test vehicle.

16. The method of claim 15, wherein the identified parameters include vibratory orders of interest.

17. The method of claim 15, wherein the identified parameters include amplitudes of vibratory orders of interest.

18. The method of claim 15, wherein the identified parameters include phase components by order.

19. A tire comprising:
a tread area;
an axis of rotation; and
a runout defined as a distance between the tread area and the axis of rotation, where the runout varies as a function of an angular position of the tire such that the tire is operative to induce a desired vibration in a vehicle while operating.

20. The tire of claim 19, wherein the tire is substantially purposely runout deformed such that the tire induces a desired vibration during vehicle testing.
